(19) United States
(12) Patent Application Publication
(10) Pub. No.: US 2024/0096118 A1
(43) Pub. Date: Mar. 21, 2024

(54) SYSTEMS AND METHODS FOR IMAGE-ASSISTED IDENTIFICATION OF PROPERTY CHANGES

(71) Applicant: JPMORGAN CHASE BANK, N.A., New York, NY (US)

(72) Inventor: Ryan EAVY, Chicago, IL (US)

(21) Appl. No.: 17/933,306

(22) Filed: Sep. 19, 2022

(51) Int. Cl. G06V 20/70; G06Q 30/06; G06V 10/10

(52) U.S. Cl. CPC G06V 20/70; G06Q 30/0645; G06V 10/17

(57) ABSTRACT

Systems and methods for determining estimated returns for image-assisted identification of property changes are disclosed. In one embodiment, a method for may include a computer program executed by mobile electronic device: (1) receiving a first image of a property captured by an image capture device at a first time; (2) identifying a plurality of first items in the first image; (3) tagging each of the plurality of first items with a first description by comparing each of the plurality of first items in the first image with a database of items and descriptions; (4) generating a list of the descriptions for the property; (5) receiving a first condition for each of the plurality of first items on the list; (6) communicating the list to a backend computer program; and (7) saving the list and descriptions.

### BACKGROUND OF THE INVENTION

### 1. Field of the Invention

Embodiments generally relate to systems and methods for image-assisted identification of property changes.

### 2. Description of the Related Art

When renting or leasing or property, such as a vehicle, the person renting or leasing the property is often required to provide the property owner or the lessor with a security deposit that will be used to pay any damages at the end of the term. There is a lack of consistency in how damage is identified and how the costs associated with the damages are calculated, leading to a lack of trust between the parties.

### SUMMARY OF THE INVENTION

Systems and methods for determining estimated returns for image-assisted identification of property changes are disclosed. In one embodiment, a method for image-assisted identification of property changes may include: (1) receiving, at a computer program executed by mobile electronic device, a first image of a property captured by an image capture device at a first time; (2) identifying, by the computer program, a plurality of first items in the first image; (3) tagging, by the computer program, each of the plurality of first items with a first description by comparing each of the plurality of first items in the first image with a database of items and descriptions; (4) generating, by the computer program, a list of the descriptions for the property; (5) receiving, by the computer program, a first condition for each of the plurality of first items on the list; (6) communicating, by the computer program, the list to a backend computer program; and (7) saving, by the backend computer program, the list and descriptions.

In one embodiment, the method may also include: receiving, at the computer program, a second image of the property captured by an image capture device at a second time; identifying, by the computer program, the plurality of first items in the second image; receiving, by the computer program, a second condition for each of the plurality of first items; identifying, by the backend computer program, a change in condition for one of the plurality of first items based on a comparison of the first condition to the second condition; determining, by the backend computer program, that the change is unacceptable by comparing the change to a policy; and determining, by the backend computer program, a cost associated with the change in condition.

In one embodiment, the method may also include: identifying, by the computer program, a plurality of second items in the second image that are not in the first image; tagging, by the computer program, each of the plurality of second items with a first description by comparing each of the plurality of second items in the second image with the database of items and descriptions; updating, by the computer program, the list with the plurality of second items; communicating, by the computer program, the updated list to the backend computer program; determining, by the backend computer program, that one of the plurality of second items is unacceptable by comparing the one second item to a policy; and determining, by the backend computer program, a cost associated with the one second item.

In one embodiment, the property may include a living area.

In one embodiment, the property may include a vehicle.

In one embodiment, the method may also include capturing, by the computer program, environmental conditions for the property at the first time.

In one embodiment, the first time may be at a beginning of a lease term, and the second time may be at an end of the lease term.

In one embodiment, each of the plurality of first items may be tagged with a location in the property and/or a description of the first item.

In one embodiment, the list may be written to a blockchain.

In one embodiment, the backend computer program may determine that the change is unacceptable by comparing the change to an expected change predicted by a trained machine learning algorithm.

In one embodiment, the trained machine learning algorithm may be trained using historical data from similar properties over a similar period of time.

According to another embodiment, a system may include: a backend electronic device executing a backend computer program; a mobile electronic device comprising an image capture device and executing a computer program; and a database comprising a mapping of images to descriptions. The computer program receives a first image of a property captured by an image capture device at a first time, may identify a plurality of first items in the first image, may tag each of the plurality of first items with a first description by comparing each of the plurality of first items in the first image with the database, may generate a list of the descriptions for the property, and may receive a first condition for each of the plurality of first items on the list; may communicate the list to a backend computer program. The backend computer program may save the list and descriptions.

In one embodiment, the computer program may receive a second image of the property captured by an image capture device at a second time, may identify the plurality of first items in the second image, and may receive a second condition for each of the plurality of first items. The backend computer program may identify a change in condition for one of the plurality of first items based on a comparison of the first condition to the second condition, may determine that the change is unacceptable by comparing the change to a policy, and may determine a cost associated with the change in condition.

In one embodiment, the computer program may receive a plurality of second items in the second image that are not in the first image, may tag each of the plurality of second items with a first description by comparing each of the plurality of second items in the second image with the database of items and descriptions, may update the list with the plurality of second items, and may communicate the updated list to the backend computer program. The backend computer program may determine that one of the plurality of second items is unacceptable by comparing the one second item to a policy, and may determine a cost associated with the one second item.

In one embodiment, the property may include a living area or a vehicle.

In one embodiment, the list may be written to a blockchain.

In one embodiment, the backend computer program may determine that the change unacceptable by comparing the change to an expected change predicted by a trained machine learning algorithm.

In one embodiment, the trained machine learning algorithm may be trained using historical data from similar properties over a similar period of time.

According to another embodiment, a non-transitory computer readable storage medium, may include instructions stored thereon, which when read and executed by one or more computer processors, cause the one or more computer processors to perform steps comprising: receiving a first image of a property captured by an image capture device at a first time; identifying a plurality of first items in the first image; tagging each of the plurality of first items with a first description by comparing each of the plurality of first items in the first image with a database of items and descriptions; generating a list of the descriptions for the property; receiving a first condition for each of the plurality of first items on the list; communicating the list to a backend computer program; receiving a second image of the property captured by an image capture device at a second time; identifying the plurality of first items in the second image; receiving a second condition for each of the plurality of first items; identifying a change in condition for one of the plurality of first items based on a comparison of the first condition to the second condition; determining that the change is unacceptable by comparing the change to a policy; and determining cost associated with the change in condition.

In one embodiment, the determination that the change is unacceptable may be based on comparing the change to an expected change predicted by a trained machine learning algorithm, wherein the trained machine learning algorithm is trained using historical data from similar properties over a similar period of time.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for image-assisted identification of property changes according an embodiment;

FIG. 2 depicts a method for image-assisted identification of property changes according an embodiment;

FIG. 3 depicts an exemplary computing system for implementing aspects of the present disclosure.

### DETAILED DESCRIPTION OF PREFERRED EMBODIMENTS

Embodiments generally relate to systems and methods for image-assisted identification of property changes.

Embodiments may leverage a series of augmented reality (AR) and/or three dimensional (3D) imagining using a handheld electronic device, compute the variances or differences in an initial state versus an exit state along with incorporating things like depreciation, normal wear and tear, etc. to determine what is owed.

Embodiments may use spatial recognition to identify, tag and remember uniqueness/patterns to establish a quality state of a given property.

In embodiments, a user, such as a renter or property owner, may capture an initial state of the property by capturing images of or other sensed data for the property. For example, the user may use a mobile electronic device, such as a smart phone, tablet computer, notebook computer, or Internet of Things (IoT) device to capture a state of the property at a first time, such as at the beginning of a lease or rental, by capturing images and/or sensed data. The process may involve scanning the layout of a space, structure/building, and then tagging the space in a larger universe of data (enabling search of units, analytics, etc.), effectively collecting metadata be able to identify locations within a given space. Imperfections, defects, and fixes are part of the structure and part of the agreement, such that the same tool may be used at time of the agreement/contract and when the agreement/contract is terminated/expired. At a second time, such as when the lease or rental is approaching maturity, or at any other time, the capture may be performed again to capture an exit state of the property. The exit state may be compared to the initial state, and any damage, changes, etc. from the initial state may be identified.

In embodiment, the collected data may be committed to a distributed ledger (e.g., a blockchain) to prevent repudiation.

Embodiments may be used for car rentals, housing rentals (short term or long term), building leases, etc., to assess a collateral value when the property is being used for a loan, to identify replacement parts when a replacement is needed, etc.

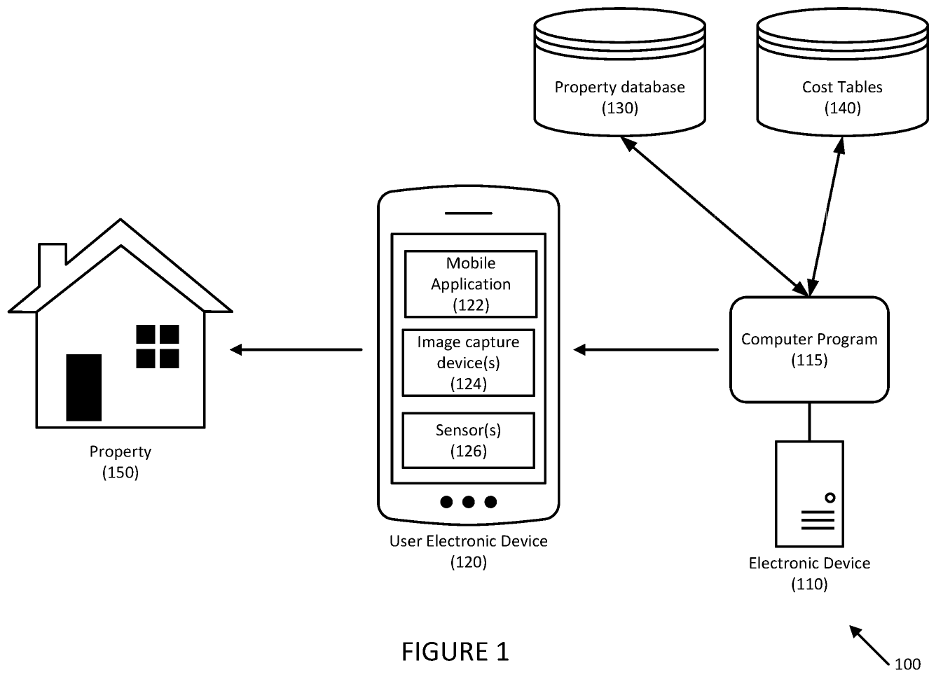

Referring to FIG. 1, a system for image-assisted identification of property changes is disclosed according to an embodiment. System 100 may include electronic device 110, which may be a server (e.g., physical and/or cloud-based), a computer (e.g., desktop, workstation, notebook, tablet, etc.), etc. Electronic device 110 may execute computer program 115.

System 100 may further include user electronic device 120 that may be any suitable electronic device, including smartphones, tablet computers, IoT devices, etc. User electronic device 120 may execute one or more computer programs or applications, such as mobile application 122.

In another embodiment, mobile application 122 may collect data regarding property 150 using, for example, image capture device(s) 124 and/or sensor(s) 126. Image capture device(s) 124 may include cameras, and may capture individual images, streams of individual images (e.g., video), etc. Sensor(s) 126 may include global positioning system (GPS) sensors, accelerometers, distance sensors (e.g., RADAR, LIDAR, SONAR, etc.).

Mobile application 122 may communicate the captured data (e.g., captured images, sensed data, etc.) to compute program 115. In one embodiment, computer program 115 and mobile application 122 may be part of the same program (e.g., distributed applications).

In one embodiment, mobile application 122 and/or computer program 115 may generate an inventory of property 150. For example, from the images and/or sensed data, mobile application 122 and/or computer program 115 may identify items in the images and may generate a catalog of those items.

System 100 may further include property database 130, which may store data on property 150. In one embodiment, database 130 may be a blockchain-based system. Database 130 may store data on more than one property 150, so that expected wear and tear may be determined. For example, an expected change in property 150 may be determined based on changes in other properties in the same area.

Property 150 may be any suitable property, including housing (e.g., apartments, condominiums, houses, etc.), commercial property (e.g., buildings), vehicles (e.g., automobiles, trucks, motorcycles, airplanes, boats, etc.), and parts thereof.

Data from property database 130 may be provided to manufacturers of different items cataloged for an assessment of item performance. For example, a paint manufacturer may be provided with paint performance over a period of time for one or more properties. A hinge manufacturer may be provided with hinge performance over a period of time for one or more properties. A tire manufacturer may be provided with tire wear for a vehicle. One or more machine learning engine may be trained with data from the images and/or sensed data, and may be used to output a prediction on expected wear and tear, when an item will fail or need to be replaced, etc.

In one embodiment, cost database 140 may store costs associated with replacement of certain items, such as tires, body panels, furniture, etc.

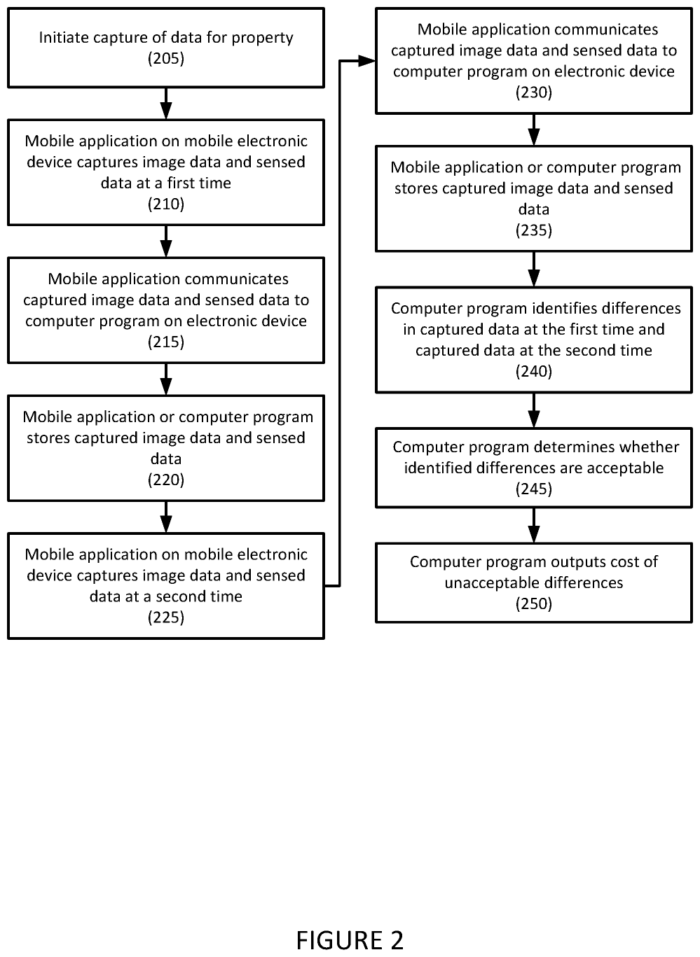

Referring to FIG. 2, a method for image-assisted identification of property changes is disclosed according to an embodiment.

In step 205, a user may initiate the capture of data for property, such as a home (e.g., apartment, home, condominium, etc.), a vehicle (e.g., automobile, motorcycle, aircraft, boat, etc.), at a first time. For example, the user may initiate the request to a mobile electronic device that may include an image capture device. In another embodiment, the user may initiate the request to an electronic device that may be in communication with one or more separate image capture devices. Any suitable mechanism may be used as is necessary and/or desired.

In step 210, a mobile application or computer program executed by a mobile electronic device may capture image data and/or sensed data at a first time, such as at the beginning of a rental or lease. In one embodiment, using an image capture device, the mobile application may capture image(s) of the property. For example, the user may scan the property using the mobile electronic device and capture images, video, etc. of the property. The mobile application may further capture any sensed data, such as location (e.g., using GPS, SONAR, RADAR, LIDAR, or other distance sensing technology), etc.

In one embodiment, additional data, such as telemetry (e.g., orientation of image capture device), ambient conditions (e.g., time of day, temperature, humidity, etc.) may be captured as is necessary and/or desired.

In addition, data specific to an industry at issue may be captured as well. For example, in a farming application, data, such as soil data, materials used, atmospheric conditions, etc. may be captured as is necessary and/or desired.

In one embodiment, as the images are being captured, the mobile application may identify items and may tag them with a description. For example, the mobile application may identify different parts of the property (e.g., different rooms, appliances, features (e.g., seats, tires, windows, doors, fixtures, etc.), etc. The mobile application may identify the items using a database of items, or may receive tags from the user.

The mobile application may generate a list of the items associated with the property. In one embodiment, the user may provide a description of the condition of the items (e.g., new, light wear, medium wear, heavy wear, missing elements, etc.). The description may be associated with the item.

In step 215, the mobile application may communicate the captured image data and sensed data to a computer program on an electronic device, such as a backend. The mobile application may further communicate the items, any description, etc. to the computer program.

In step 220, the mobile application or computer program may store the captured image data, the sensed data, and the items/descriptions. In one embodiment, the captured data may be stored in a database. In another embodiment, the captured data may be committed to a distributed ledger (e.g., a blockchain).

In step 225, the mobile application may capture image data and sensed data at a second time, such as at the end of a rental or lease. In one embodiment, data that is similar to the data captured in step 210 may be captured. The mobile application may also generate a list of the items associated with the property. In one embodiment, the user may provide a description of the condition of the items (e.g., new, light wear, medium wear, heavy wear, missing elements, etc.). The description may be associated with the item.

In step 230, the mobile application may communicate the captured image data, the sensed data, and the items/descriptions to the computer program on the electronic device. This may be similar to step 215.

In step 235, the mobile application or computer program may store the captured image data, the sensed data, and the items/descriptions. This may be similar to step 220.

In step 240, the computer program may compare the data captured at the first time and the captured data at the second time, and may identify any differences. For example, the computer program may normalize the images using, for example, metadata for the images, and may identify any differences. In one embodiment, the computer program may identify added, changed, or missing items, changes to the condition of an item, changes in item brands or manufacturer, changes to the property (e.g., different colors), etc.

In one embodiment, the computer program may assess any items that have been added, changed, or missing, or changed in condition. For example, the computer program may identify the scope of the change in condition (e.g., a tear, worn carpet, scratches, dents, tire tread wear, etc.) to determine whether the change in condition is acceptable.

In step 245, the computer program may determine whether identified differences are acceptable by comparing the changes in condition to a policy. The policy may be provided by the owner or lessor of the property, and may be based on any suitable factors including, for example, the length of the rental or lease, pre-existing damage to the property, environmental factors, etc. In one embodiment, the computer program may use a trained machine learning engine that is trained on various similar properties to determine an expected amount of change in condition.

In step 250, based on the determination of what is acceptable, the acceptable computer program may determine a cost associated with the change in condition, and may assess the renter or lessee.

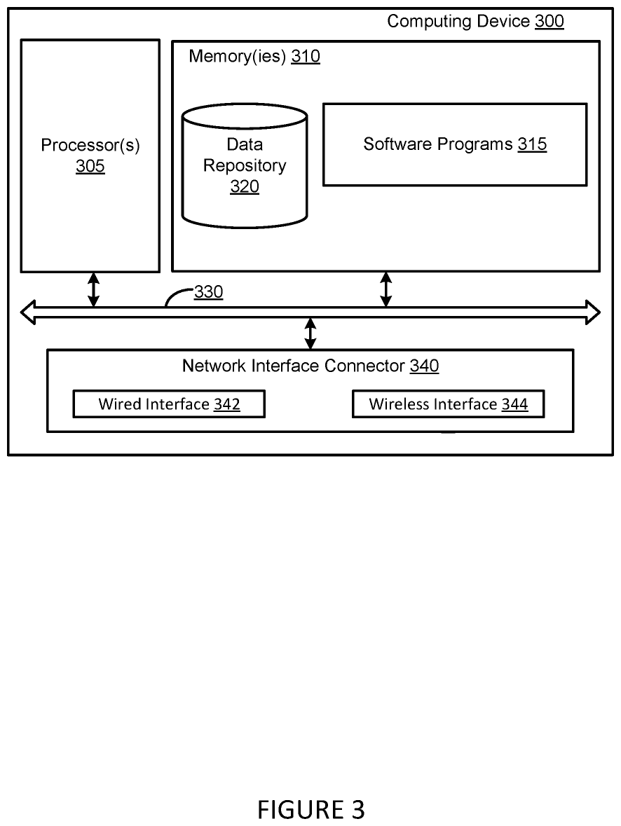

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although multiple embodiments have been disclosed, it should be recognized that these embodiments are not exclusive to each other, and features from one embodiment may be used with other embodiments.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Further, it is not necessary that a single type of instruction or single programming language be utilized in conjunction with the operation of the system and method. Rather, any number of different programming languages may be utilized as is necessary and/or desired.

Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for image-assisted identification of property changes, comprising:
receiving, at a computer program executed by mobile electronic device, a first image of a property captured by an image capture device at a first time;
identifying, by the computer program, a plurality of first items in the first image;
tagging, by the computer program, each of the plurality of first items with a first description by comparing each of the plurality of first items in the first image with a database of items and descriptions;
generating, by the computer program, a list of the descriptions for the property;
receiving, by the computer program, a first condition for each of the plurality of first items on the list;
communicating, by the computer program, the list to a backend computer program; and
saving, by the backend computer program, the list and descriptions.

2. The method of claim 1, further comprising:
receiving, at the computer program, a second image of the property captured by an image capture device at a second time;
identifying, by the computer program, the plurality of first items in the second image;
receiving, by the computer program, a second condition for each of the plurality of first items;
identifying, by the backend computer program, a change in condition for one of the plurality of first items based on a comparison of the first condition to the second condition;
determining, by the backend computer program, that the change is unacceptable by comparing the change to a policy; and
determining, by the backend computer program, a cost associated with the change in condition.

3. The method of claim 2, further comprising:
identifying, by the computer program, a plurality of second items in the second image that are not in the first image;
tagging, by the computer program, each of the plurality of second items with a first description by comparing each of the plurality of second items in the second image with the database of items and descriptions;
updating, by the computer program, the list with the plurality of second items;
communicating, by the computer program, the updated list to the backend computer program;
determining, by the backend computer program, that one of the plurality of second items is unacceptable by comparing the one second item to a policy; and
determining, by the backend computer program, a cost associated with the one second item.

4. The method of claim 1, wherein the property comprises a living area.

5. The method of claim 1, wherein the property comprises a vehicle.

6. The method of claim 1, further comprising:
capturing, by the computer program, environmental conditions for the property at the first time.

7. The method of claim 2, wherein the first time is at a beginning of a lease term, and the second time is at an end of the lease term.

8. The method of claim 1, wherein each of the plurality of first items is tagged with a location in the property and/or a description of the first item.

9. The method of claim 1, wherein the list is written to a blockchain.

10. The method of claim 2, wherein the backend computer program determines that the change is unacceptable by comparing the change to an expected change predicted by a trained machine learning algorithm.

11. The method of claim 10, wherein the trained machine learning algorithm is trained using historical data from similar properties over a similar period of time.

12. A system, comprising:
a backend electronic device executing a backend computer program;
a mobile electronic device comprising an image capture device and executing a computer program; and
a database comprising a mapping of images to descriptions;
wherein:
the computer program receives a first image of a property captured by an image capture device at a first time;
the computer program identifies, a plurality of first items in the first image;
the computer program tags each of the plurality of first items with a first description by comparing each of the plurality of first items in the first image with the database;
the computer program generates a list of the descriptions for the property;
the computer program receives a first condition for each of the plurality of first items on the list;
the computer program communicates the list to a backend computer program; and
the backend computer program saves the list and descriptions.

13. The system of claim 12, wherein:
the computer program receives a second image of the property captured by an image capture device at a second time;
the computer program identifies the plurality of first items in the second image;
the computer program receives a second condition for each of the plurality of first items;
the backend computer program identifies a change in condition for one of the plurality of first items based on a comparison of the first condition to the second condition;
the backend computer program determines that the change is unacceptable by comparing the change to a policy; and
the backend computer program determines a cost associated with the change in condition.

14. The system of claim 13, wherein:
the computer program receives a plurality of second items in the second image that are not in the first image;
the computer program tags each of the plurality of second items with a first description by comparing each of the plurality of second items in the second image with the database of items and descriptions;
the computer program updates the list with the plurality of second items;
the computer program communicates the updated list to the backend computer program;
the backend computer program determines that one of the plurality of second items is unacceptable by comparing the one second item to a policy; and
the backend computer program determines a cost associated with the one second item.

15. The system of claim 12, wherein the property comprises a living area or a vehicle.

16. The system of claim 12, wherein the list is written to a blockchain.

17. The system of claim 13, wherein the backend computer program determines that the change is unacceptable by comparing the change to an expected change predicted by a trained machine learning algorithm.

18. The system of claim 17, wherein the trained machine learning algorithm is trained using historical data from similar properties over a similar period of time.

19. A non-transitory computer readable storage medium, including instructions stored thereon, which when read and executed by one or more computer processors, cause the one or more computer processors to perform steps comprising:
receiving a first image of a property captured by an image capture device at a first time;
identifying a plurality of first items in the first image;
tagging each of the plurality of first items with a first description by comparing each of the plurality of first items in the first image with a database of items and descriptions;
generating a list of the descriptions for the property;
receiving a first condition for each of the plurality of first items on the list;
communicating the list to a backend computer program;
receiving a second image of the property captured by an image capture device at a second time;
identifying the plurality of first items in the second image;
receiving a second condition for each of the plurality of first items;
identifying a change in condition for one of the plurality of first items based on a comparison of the first condition to the second condition;
determining that the change is unacceptable by comparing the change to a policy; and
determining cost associated with the change in condition.

20. The non-transitory computer readable storage medium of claim 19, wherein the determination that the change is unacceptable is based on comparing the change to an expected change predicted by a trained machine learning algorithm, wherein the trained machine learning algorithm is trained using historical data from similar properties over a similar period of time.
